(19) United States
(12) Patent Application Publication
(10) Pub. No.: US 2014/0060344 A1
(43) Pub. Date: Mar. 6, 2014

(54) Apparatus for Removing Liquid from a Can

(71) Applicant: Joseph E. Saunders, Tigard, OR (US)

(72) Inventor: Joseph E. Saunders, Tigard, OR (US)

(21) Appl. No.: 14/011,891

(22) Filed: Aug. 28, 2013

Related U.S. Application Data
(60) Provisional application No. 61/693,895, filed on Aug. 28, 2012.

(51) Int. Cl. A47J 19/00

(52) U.S. Cl. CPC A47J 19/005
USPC 99/495

(57) ABSTRACT

An apparatus for squeezing liquid from an opened can of tuna is provided. The apparatus comprises a cylindrical base container for receiving an opened can, a top plate for placing over the opened can, and a compression element for squeezing the top plate into the opened can. As the top plate is squeezed into the opened can, the packing liquid is squeezed out through a gap between an edge of the top plate and an inside circumference of the opened can.

### CROSS-REFERENCE

This application claims priority from Provisional Patent Application Ser. No. 61/693,895 filed Aug. 28, 2012.

### FIELD OF THE INVENTION

This invention pertains generally to an apparatus for draining liquid from a can, and more particularly to an apparatus for squeezing liquid from a can of solid food packed in oil or water.

### BACKGROUND

Canned meats or fish, such as tuna or salmon, are typically packaged in a can with water or oil. After opening the can, the fluid is usually drained by pressing the opened lid of the can down into the tuna with the user's hands. The user must apply a significant amount of pressure with their thumbs to remove a majority of the fluid. This can be difficult for the elderly or for individuals with disabilities.

During the draining process, the packing liquid can squirt out of the sides of the can and splatter on the kitchen counter, making a mess. Similarly, the packing fluid can get all over the user's hands and run down their arms. As the packing fluid generally absorbs the odors of the food, the sent of tuna or other packaged proteins is transferred to any contacted surfaces such as the user's hands, arms, and clothes. Additionally, using the lid to drain the packing fluid can easily contaminate the packed food with any dirt, germs, or microorganisms found on the exterior of the lid or on the user's hands. The user would have to wash both their hands and the can prior to draining to avoid this contamination.

Consequently, there exists a need for a device designed to provide an easy to use kitchen utensil for removing packing liquid from a can of tuna, salmon, chicken, and the like. The proposed invention allows a user to drain this fluid without creating a mess, contaminating the packed food, and with minimal exertion. The apparatus allows a user to easily apply pressure to the top of the opened can of food using a mechanical advantage. Once the pressure has been applied and the fluid removed from the can, the apparatus is inverted and the packing fluid is easily discarded. Once the liquid has been discarded, the can is removed from the device, and the remaining drained food is consumed.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an apparatus for removing a packing liquid from a can of food such as tuna. The apparatus comprises a cylindrical base container, a top plate , and a compression element. After removing a lid from the can of food, the can is placed into the cylindrical base container. The top plate is positioned within the opened can in place of the removed lid. The compression element is used to apply pressure to both a bottom of the cylindrical base container, and the top plate, thereby pushing the top plate into the opened can. As the top plate is pushed in, the packing liquid is squeezed out of the can and into the cylindrical base container. The fluid is then discarded by inverting the apparatus over a sink. The pressure is then released, the can removed, and the drained food eaten.

Furthermore, in a preferred embodiment of the invention the compression element comprises a ratchet component for providing a mechanical advantage, a handgrip, and a pair of opposing heads. The ratchet component allows the user to exert minimal pressure on the handgrip, while still maintaining a constant pressure between the top plate and the bottom of the cylindrical base container which are sandwiched between the pair of opposing heads. Once a sufficient amount of the packing liquid is drained, the ratchet component is released, and the compression element is removed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of an apparatus for squeezing liquid from an opened can in accordance with the disclosed architecture.

FIG. 2 illustrates a perspective view of an opened can of tuna in accordance with the disclosed architecture.

FIG. 3 illustrates a perspective view of the apparatus engaging the opened can of tuna in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter. The invention relates generally to an apparatus for pressing a packing fluid from an opened can of tuna.

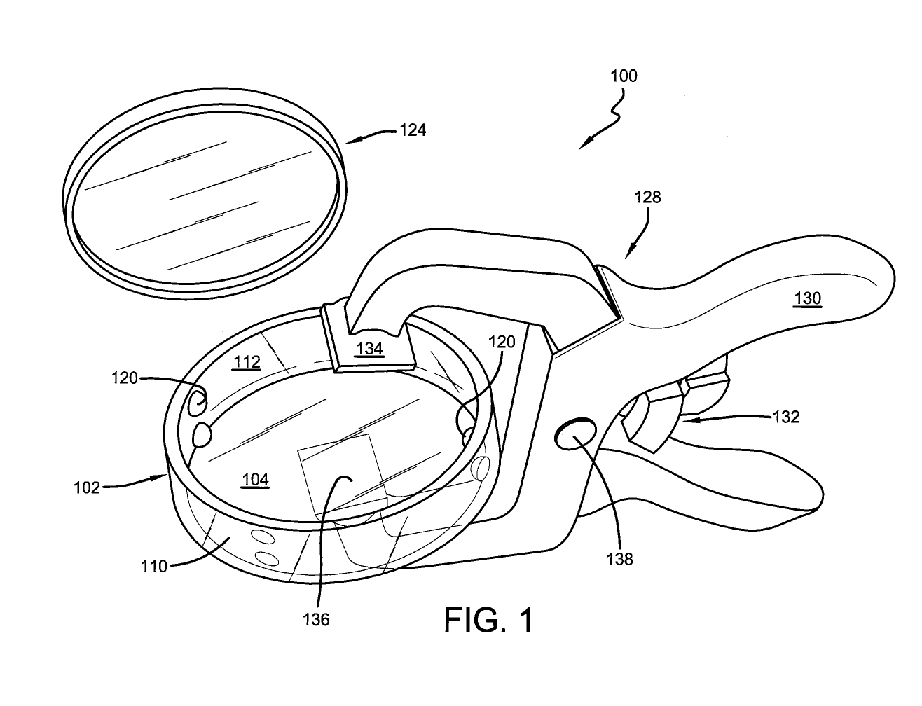

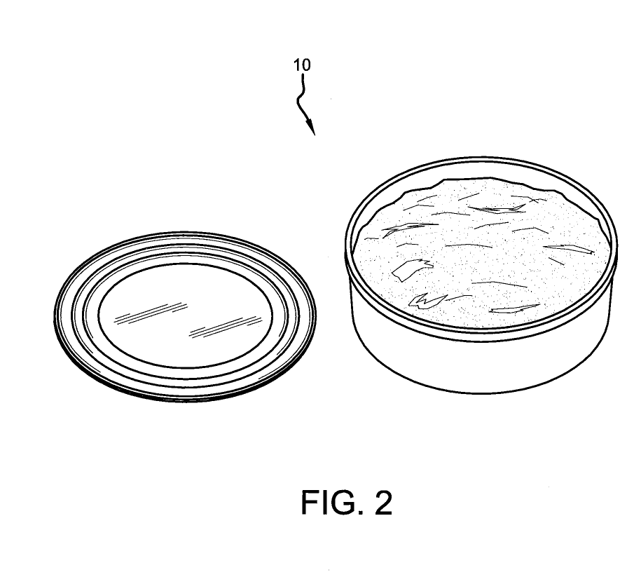

Referring initially to the drawings, FIGS. 1-3 illustrate an apparatus 100 for squeezing liquid from an opened can 10. The apparatus 100 comprises a cylindrical base container 102, a top plate 124, and a compression element 128. The cylindrical base container 102 is preferably sized to receive a typical 4½ to six ounce can of food packed in a liquid. Typically, the apparatus 100 is used in conjunction with cans of tuna fish, however, any food packed in a liquid where draining is advantageous such as, but not limited to salmon, chicken, vegetables, and the like may be used with the apparatus 100 as well. Additionally, an embodiment where the cylindrical base container 102 may comprise larger sizes to accommodate larger volume cans of food may be used without affecting the overall scope of the invention.

The cylindrical base container 102 comprises a bottom 104, a sidewall 110, and an open top. The bottom 104 is circular with a diameter slightly larger than a diameter of the opened can 10. The sidewall 110 is generally cylindrical and extends out of the bottom 104 substantially perpendicular to a circumference of the bottom 104. The sidewall 110 terminates in the open top. The sidewall 110 is approximately between ¾ and 1½ inches in height, however, the dimensions may be larger or smaller as desired without affecting the overall scope of the invention. The sidewall 110 is typically dimensioned to substantially encapsulate a circumference of the opened can 10.

The sidewall 110 further comprises a plurality of spacers 120 extending inward from an inner circumference 112 of the sidewall 110. The inner circumference 112 of the sidewall 110 is generally approximately between ⅛ and ½ inches greater in diameter than the diameter of the opened can. The plurality of spacers 120 are typically hard plastic beads or knobs affixed to the inner circumference 112 of the sidewall 110 with glue, adhesive, epoxy, or the like. The plurality of spacers 120 serve to hold the opened can 10 in place within the cylindrical base container 102. The user slides the opened can 10 between the sidewall 110 so that it rests on the bottom 104 of the cylindrical base container 102. The plurality of plastic spacers 120 keep the opened can 10 from moving around within the cylindrical base container 102.

Once the opened can 10 is placed within the cylindrical base container 102, the top plate 124 may be placed into the opened can 10 on top of the tuna saturated in liquid. The top plate 124 is essentially a round plastic disc having a diameter slightly less than the diameter of the opened can 10. The diameter of the top plate 124 must be small enough to permit the liquid to escape between a perimeter of the top plate 124, and an internal sidewall of the opened can 10. Typically, the diameter of the top plate will be approximately between 1/16 and ¼ inches smaller in diameter than a diameter of the internal sidewall of the opened can 10 , although it may vary depending on the diameter of the opened can 10.

The compression element 128 uses a ratcheting mechanism, similar to a vice grip to provide a mechanical advantage in pressing the top plate 124 into the opened can 10. The compression element 128 comprises a handgrip 130, a ratchet component 132, a first head 134, and a second head 136. The hand grip 130 is typically an ergonomically shaped grip, such as but not limited to a bicycle grip, a tool grip, and the like.

The first head 134 and the second head 136 are essentially mirror image gripping surfaces forming a pair of opposing heads. Both the first head 134 and the second head 136 are approximately between ¾ and 1½ square inches in surface area. This allows for even and uniform pressure to be exerted on the cylindrical base container 102 and the top plate 124. The first head 134 and the second head 136 extend out of the hand grip 130 with the ratchet component 132 located in between. Typically, the second head 136 is adhesively attached to an outside surface of the bottom 104 of the cylindrical base container 102. The second head 136 may be attached by adhesive, applied heat, radio frequency welding, mechanical fasteners, and the like, or by any other means of attachment known to one of skill in the art. Alternatively, the inventor contemplates an embodiment where the second head 136 is removably attachable to the bottom 104 of the cylindrical base container 102 as well. The first head 134 is unattached to the cylindrical base container 102 or the top plate 124 and is used to selectively engage the top plate 124 as described infra.

The ratchet component 132 is typically a gear and spring loaded lever ratcheting system as is known in the art. The ratchet component 132 is engaged by squeezing the handgrip 130 to adjust a distance between the first head 134 and the second head 136. As the first head 134 and the second head 136 are ratcheted closer together, pressure is exerted on the top plate 124, and it is pushed into the opened can 10 thereby displacing the liquid. Once initially squeezed, the pressure applied to the top plate 124 remains uniform without the need to maintain the squeezing force on the handgrip 130 as the ratchet component 132 maintains the pressure.

The compression element 128 further comprises a ratchet release mechanism 138 for releasing the tension in the ratchet component 132. The ratchet release mechanism is typically a push button, or spring lever located on the handgrip 130 or the ratchet component 132 for disengaging or releasing the pressure on the ratchet component 132. Once enough liquid is displaced and discarded, the ratchet release mechanism 138 is triggered, and the pressure between the first head 134 and the second head 136 is released.

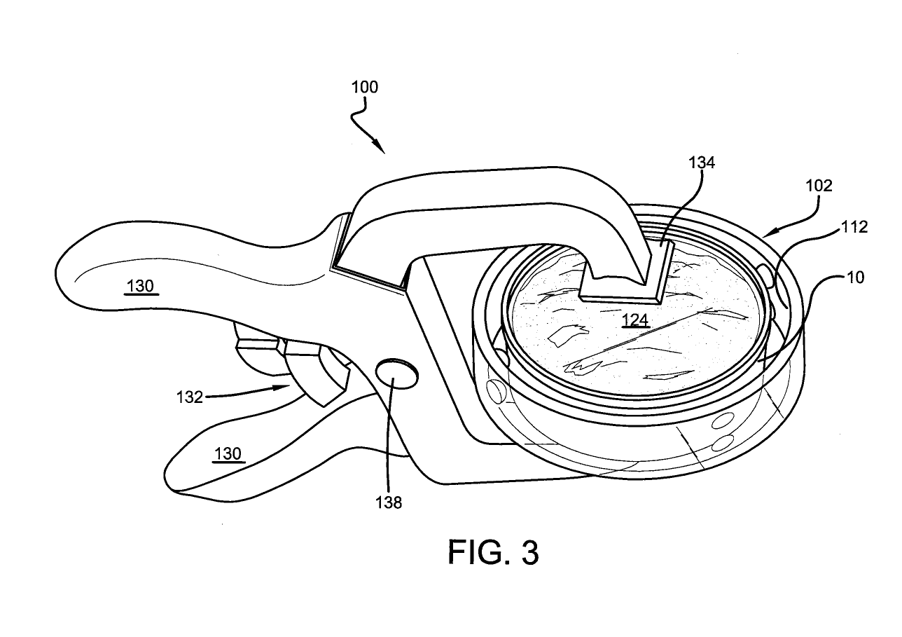

As illustrated in FIG. 3, to use the apparatus 100, the opened can 10 is placed into the cylindrical base container 102. The plurality of spacers 120 hold the opened can 10 securely within the cylindrical base container 102. The top plate 124 is placed in the opened can 10 atop the food. The first head 134 of the compression element 128 is placed adjacent to the top plate 124 opposite the first head 134, and pushes the top plate 124 into the opened can 10 as the ratchet component 132 is engaged. Once a desired amount of liquid is forced out of the opened can 10, the apparatus 100 is inverted and the liquid is allowed to drain out of the cylindrical base container 102. Once drained, the ratchet component is disengaged, the opened can 10 is removed from the apparatus 100, and the tuna may be removed from the opened can 10.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for squeezing liquid from an opened can comprising:
a cylindrical base container for receiving the opened can, the base container comprising a bottom, a sidewall, and an open top;
a top plate for placing into the opened can; and
a compression element for pressing the top plate into the opened can held by the base container.

2. The apparatus of claim 1, wherein the base container is larger in diameter than the opened can.

3. The apparatus of claim 2, wherein the top plate is smaller in diameter than the opened can.

4. The apparatus of claim 1, wherein the sidewall comprises a plurality of spacers for engaging the opened can, the plurality of spacers extending inward from an inner circumference of the sidewall.

5. The apparatus of claim 1, the compression element comprising a first head attached to an outside of the bottom of the cylindrical base container, and a second head for engaging the top plate.

6. The apparatus of claim 5, the compression element further comprises a ratchet component for adjusting a distance between and connecting the first and the second heads.

7. An apparatus for squeezing liquid from an opened can of food comprising:
a cylindrical base container for receiving the opened can, the base container comprising a bottom, a sidewall, an open top, wherein the base container is larger in diameter than the opened can; and
a top plate for placing into the opened can of food, wherein the top plate is smaller in diameter than the opened can; and
a compression element attached to the bottom of the base for pressing the top plate into the opened can held by the base container.

8. The apparatus of claim 7, wherein the sidewall comprises a plurality of spacers for engaging the opened can, the plurality of spacers extending inward from an inner circumference of the sidewall.

9. The apparatus of claim 7, wherein the top plate is approximately between 1/16 and ¼ inches less in diameter than the opened can.

10. The apparatus of claim 7, wherein the compression element comprises a handgrip, a pair of opposing heads extending from the handgrip, and a ratchet component located between the handgrip and the pair of opposing heads.

11. The apparatus of claim 10, wherein the ratchet component adjusts a distance and maintains a pressure between the pair of opposing heads.

12. The apparatus of claim 11, the compression element further comprising a ratchet release mechanism for releasing the pressure between the pair of opposing heads.

13. The apparatus of claim 7, wherein the pair of opposing heads each have a surface area of approximately between ¾ and 1½ square inches.

14. An apparatus for squeezing liquid from an opened can of tuna comprising:
a cylindrical base container for receiving the opened can, the base container comprising a bottom, a sidewall, and an open top;
a top plate sized to fit within the opened can of tuna; and
a compression element attachable to the bottom of the base for pressing the top plate into the opened can of tuna held by the base container, wherein the compression element comprises a ratchet component.

15. The apparatus of claim 14, wherein the sidewall comprises a plurality of spacers for engaging the opened can, the plurality of spacers extending inward from an inner circumference of the sidewall.

16. The apparatus of claim 14, wherein the top plate is approximately between 1/16 and ¼ inches less in diameter than the opened can of tuna.

17. The apparatus of claim 14, wherein the cylindrical base is approximately between ⅛ and ½ inches greater in diameter than the opened can of tuna.

18. The apparatus of claim 14, the compression element further comprising a handgrip, a pair of opposing heads extending from the handgrip, wherein the ratchet component is located between the handgrip and the pair of opposing heads.

19. The apparatus of claim 18, wherein the handgrip comprises an ergonomic shape.

20. The apparatus of claim 14, wherein one of the pair of heads is removably attached to the bottom of the base.
